(19) United States
(12) Patent Application Publication
(10) Pub. No.: US 2026/0225625 A1
(43) Pub. Date: Aug. 6, 2026

(54) Method for Detecting Presence of Person in Seat

(71) Applicant: Autonomous Solutions, Inc., Mendon, UT (US)

(72) Inventor: Taylor Bybee, Mendon, UT (US)

(73) Assignee: Autonomous Solutions, Inc., Mendon, UT (US)

(21) Appl. No.: 19/312,281

(22) Filed: Aug. 27, 2025

Related U.S. Application Data
(60) Provisional application No. 63/753,945, filed on Feb. 5, 2025.

(51) Int. Cl. B60W 60/00; B60R 21/015; B60W 40/08

(52) U.S. Cl. CPC B60W 60/0053; B60R 21/01516; B60R 21/01538; B60W 40/08; B60W 2040/0881; B60W 60/0059; B60W 2420/408

(57) ABSTRACT

An autonomous vehicle is disclosed. The autonomous vehicle may include an operator seat, an occupancy system to capture occupancy data, wherein an operator volume is in a field of view of the occupancy system, the operator volume being defined as a volume above the operator seat in which an operator may or may not be seated, a vehicle control unit for controlling movement of the autonomous vehicle, a digital storage comprising field-of-view data representing the field of view of the occupancy system; and an operator detection system which receives field-of-view data and occupancy data; identifies occupancy points within the operator volume; and if the total number of occupancy points in the operator volume exceeds an occupancy threshold for a predetermined period of time, determining that an operator is located in the operator seat; and sending a stop signal to the vehicle control unit to stop the autonomous vehicle.

### BACKGROUND

Autonomous vehicle systems typically have safety systems to enable safe autonomous use of the vehicle. These often include sensors and methods to detect that there are no people around the autonomous vehicle while it is moving to safeguard people.

### SUMMARY

Systems and methods for improving safety of an autonomous vehicle are described.

According to an aspect, there is provided an autonomous vehicle comprising: an operator seat; an occupancy system comprising one or more remote occupancy sensors to capture occupancy data comprising a plurality of occupancy points, wherein a three-dimensional operator volume is in a field of view of the occupancy system, the operator volume being defined as a volume above the operator seat in which an operator may be located when sitting in the operator seat; a vehicle control unit for autonomously controlling movement of the autonomous vehicle; a digital storage medium comprising field-of-view data representing the field of view of the occupancy system, the field-of-view data including a representation of the operator volume; and an operator detection system in communication with the digital storage medium, occupancy system, and the vehicle control unit, wherein the operator detection system performs an operator check by:
receiving the field-of-view data from the digital storage medium; receiving the occupancy data from the occupancy system; identifying occupancy points within the operator volume of the field-of-view data; and if the total number of occupancy points in the operator volume exceeds an occupancy threshold for a predetermined period of time, determining that an operator is located in the operator seat; and in response to determining that an operator is located in the operator seat, sending a stop signal to the vehicle control unit to stop autonomous movement of the autonomous vehicle.

The autonomous vehicle may comprise a seat sensor in the operator seat which detects the presence of an operator in the operator seat.

The stop signal may be sent to the vehicle control unit further when the seat sensor detects the presence of an operator on the operator seat.

Autonomous movement of the autonomous vehicle may only be permitted when the seat sensor does not detect the presence of an operator on the operator seat and when the total number of occupancy points in the operator volume does not exceed the occupancy threshold for a predetermined period of time.

The seat sensor may be a pressure sensor to detect the weight of an operator on the operator seat. The operator detection system may determine that an operator is located in the operator seat when the pressure sensors detects a pressure higher than a pressure threshold.

The field-of-view data may be generated by the occupancy system. The field-of-view data may include a point cloud or an occupancy grid representing fixed objects, including the operator volume, in the field of view of the occupancy system.

When the stop signal is sent to the vehicle control unit, manual control of the autonomous vehicle may be enabled.

The operator detection system may perform the operator check regularly, at predetermined time intervals, when the vehicle control unit autonomously controls movement of the autonomous vehicle.

The occupancy sensor may be a Lidar sensor to capture Lidar data comprising a plurality of Lidar points.

According to an aspect, there is provided a method comprising: receiving field-of-view data representing a field of view of an occupancy system on an autonomous vehicle, including a view of an operator seat on the autonomous vehicle and a three-dimensional operator volume defined as a volume above the operator seat in which an operator may be located when sitting in the operator seat; receiving occupancy data, comprising a plurality of occupancy points, captured by the occupancy system on the autonomous vehicle; identifying occupancy points within the operator volume; and if the total number of occupancy points in the operator volume exceeds an occupancy threshold for a predetermined period of time, determining that an operator is located in the operator seat; and in response to determining that an operator is located in the operator seat, sending a stop signal to a vehicle control unit on the autonomous vehicle to stop autonomous movement of the autonomous vehicle.

The method may comprise receiving a seat signal from a seat sensor on the autonomous vehicle. The method may comprise determining the presence of an operator in the operator volume when the seat signal indicates the presence of a person in the operator seat. The method may comprise sending a stop signal to the vehicle control unit when the seat signal indicates the presence of a person in the operator seat.

Autonomous movement of the autonomous vehicle may only be permitted when both the seat signal indicates the that there is no person present in the operator seat and when the total number of occupancy points in the operator volume does not exceed the occupancy threshold for a predetermined time period.

The seat signal may be a pressure signal from a pressure sensor to detect the weight of an operator on the operator seat. The method may comprise determining that an operator is located in the operator seat when the pressure sensors detects a pressure higher than a pressure threshold.

The field-of-view data may be generated by the occupancy system. The field-of-view data may include a point cloud or an occupancy grid representing fixed objects in the field of view of the occupancy system.

The method may comprise enabling manual control of the autonomous vehicle when the stop signal is sent to the vehicle control unit.

The method may be performed when the autonomous vehicle is being autonomously controlled.

The occupancy sensor may be a Lidar sensor to capture Lidar data comprising a plurality of Lidar points.

According to an aspect, there is provided, an autonomous vehicle comprising: an operator seat; a pressure sensor in the operator seat which detects the presence of an operator on the operator seat by detecting the weight of an operator on the operator seat; a Lidar system comprising one or more Lidar sensors to capture Lidar data including a plurality of Lidar points, wherein a three-dimensional operator volume is in a field of view of the Lidar system, the operator volume being defined as a volume above the operator seat in which an operator may be located when sitting in the operator seat; a vehicle control unit for autonomously controlling movement of the autonomous vehicle; a digital storage medium comprising field-of-view data representing the field of view of the Lidar system, the field-of-view data including a representation of the operator volume; and an operator detection system in communication with the digital storage medium, Lidar system, and the vehicle control unit, wherein the operator detection system regularly performs an operator check, at predetermined time intervals, when the vehicle control unit autonomously controls movement of the autonomous vehicle, the operator check comprising:
receiving field-of-view data from the digital storage medium; receiving the Lidar data from the Lidar system; identifying Lidar points within the operator volume; and calculating the total number of Lidar points in the operator volume and if (i) the total number of Lidar points in the operator volume exceeds a Lidar threshold for a predetermined period of time, and/or (ii) the pressure sensor detects the presence of an operator on the operator seat:
   determining that an operator is located in the operator seat and sending a stop signal to the vehicle control unit to stop autonomous movement of the autonomous vehicle; wherein autonomous movement of the autonomous vehicle is only permitted when it can be determined from signals from both the Lidar system and the pressure sensor that there is no operator present on the operator seat.

The various examples described in the summary and this document are provided not to limit or define the disclosure or the scope of the claims.

### BRIEF DESCRIPTION OF THE FIGURES

FIG. 1 is a side view of an autonomous yard truck according to some embodiments.

FIG. 2 illustrates a block diagram of an example autonomous vehicle communication system of the present disclosure according to some embodiments.

FIG. 3. is a flow diagram showing steps of a method of controlling an example autonomous vehicle according to some embodiments.

FIG. 4 is a side view of an autonomous tractor according to some embodiments.

FIG. 5 is a side view of an autonomous mower according to some embodiments.

FIG. 6 is a block diagram of an example computational system (or controller).

### DETAILED DESCRIPTION

Systems and/or methods are disclosed for improving safety of an autonomous vehicle.

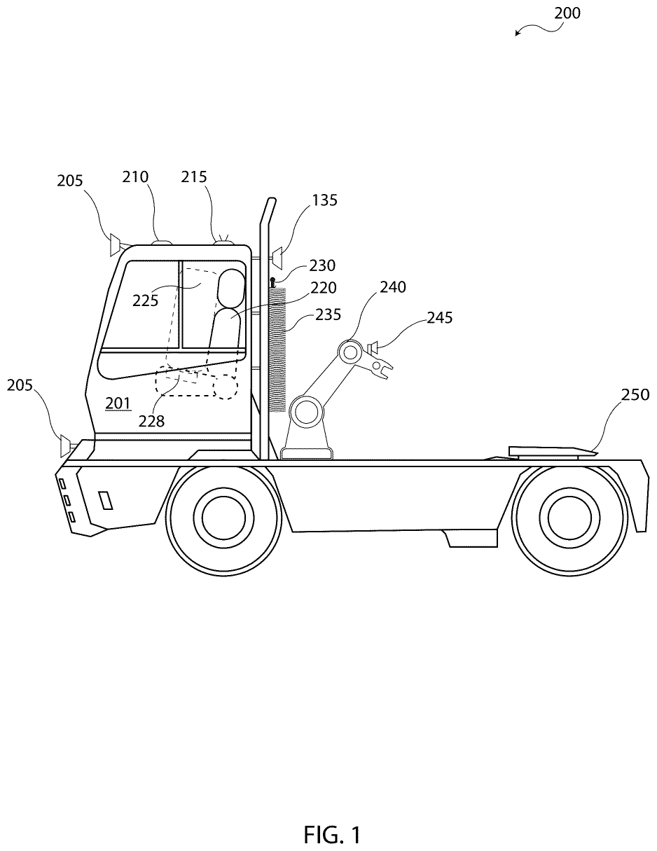

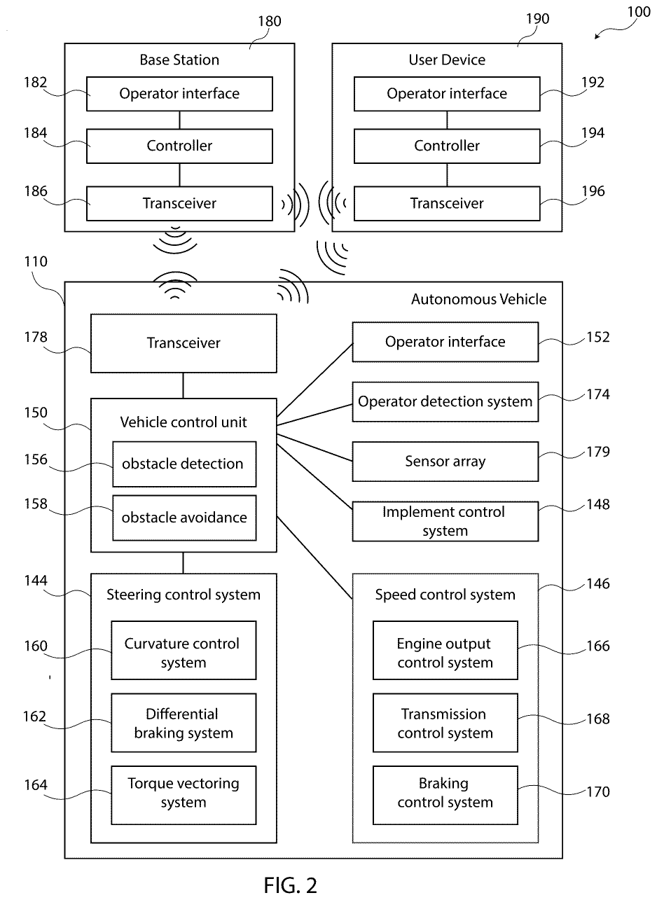

FIG. 1 is a side view of an autonomous yard truck 200 according to some embodiments. The autonomous yard truck 200 includes a cab 201 that may be used to drive the autonomous yard truck 200 manually, and an operator seat 220 located within the cab 201, in which an operator may sit. The autonomous yard truck 200 may include one or more controllers as shown in FIG. 2. The autonomous yard truck 200 may also include a brake system, an engine, a transmission, steering, etc.

In some embodiments, the autonomous yard truck 200 may include a sensor array (such as sensor array 179, described with reference to FIG. 2) that includes sensors 205 disposed at various locations on the autonomous yard truck 200 such as, for example, on the cab 201, bumper, housing, frame, etc. The sensors 205 may include infrared sensors, ultrasonic sensors, magnetic sensors, radar sensors, Lidar sensors, occupancy sensors, terahertz sensors, sonar sensors, cameras, stereo cameras etc. The sensors 205 may include, in particular, an occupancy system including one or more remote occupancy sensors 205a which collectively or individually have a field of view including a three-dimensional operator volume 225 within the cab 201 of the autonomous yard truck 200, the operator volume 225 defined as a volume above the operator seat 220 in which an operator may be located when sitting on the operator seat 220. The occupancy system may be a Lidar system where the occupancy sensors 205a are Lidar sensors 205a. In some examples, the occupancy sensors may include radar sensors or stereo cameras, or any other suitable remote sensor having a field of view of at least the operator volume in the cab 201.

The operator volume 225 in this example is a simple cuboid but may be any suitable three-dimensional shape in other examples. In this example, there are two occupancy sensors 205a shown within the cab 201 having a field of view including at least some of the operator volume 225 such that, between the two occupancy sensors 205a, a collective field of view includes the whole operator volume 225. In other examples, there may be only one occupancy sensor 205a, which may have a field of view including the whole operator volume 225, or there may be more than two occupancy sensors 205a which each have a field of view including at least some of the operator volume 225. With more than one occupancy sensor 205a, each occupancy sensor 205a may be positioned and angled so that the field of view of each occupancy sensor 205a may be stitched together to create a field of view including the whole operator volume 225. The autonomous yard truck 200 may also include one or more backup sensors 135 such as, for example, infrared sensors, ultrasonic sensors, magnetic sensors, radar sensors, Lidar sensors, terahertz sensors, sonar sensors, cameras, stereo cameras etc.

In some embodiments, the autonomous yard truck 200 may include a seat sensor 228 in the operator seat 220, which may detect the presence of an operator sitting on the operator seat 220. In some embodiments, the seat sensor 228 may be a pressure sensor, configured to detect the weight of an operator on the operator seat 220 when the pressure sensor detects an increase in pressure. The seat sensor 228 may detect the presence of an operator on the operator seat when the pressure reading is above a threshold pressure. The seat sensor 228 may be considered a part of a sensor array, such as the sensor array 179 described in FIG. 2.

In some embodiments, the autonomous yard truck 200 may include a spatial locating device (or GPS) antenna 210. In some embodiments, the autonomous yard truck 200 may include a transceiver antenna 215.

In some embodiments, the autonomous yard truck 200 may include one or more hoses 235 that can be connected with the trailer 260 such as, for example, two or three hoses. Each hose may have a hose connector 230 that can be connected with a trailer hose connector 265. For example, the autonomous yard truck 200 may include a service brake hose, an emergency brake hose, and/or a refrigerant hose.

In some embodiments, the autonomous yard truck 200 may include a robotic arm 240 disposed on the back bed of the autonomous yard truck 200. The robotic arm 240 may include any type of robotic arm. The robotic arm 240, for example, may exert high torque or high pressure sufficient to connect the hose connector 230 with the trailer hose connector 265. The hose connector 230 and/or the trailer hose connector 265 may comprise a glad-hand connector. In some embodiments, when the autonomous yard truck 200 is not coupled with a trailer 260, the hose connector 230 may be positioned in a storage rack at some point on the autonomous yard truck 200 such as, for example, on the rear of the cab 201.

In some embodiments, the robotic arm 240 may include one or more arm sensors 245 such as, for example, infrared sensors, ultrasonic sensors, magnetic sensors, radar sensors, Lidar sensors, terahertz sensors, sonar sensors, cameras, stereo cameras etc. The arm sensor 245, for example, may produce data that can be used to identify the location of a hose connector 230 and/or a trailer hose connector 265. The arm sensor 245, for example, may produce data that can show that a hose connector 230 and/or a trailer hose connector 265 are sufficiently coupled.

In some embodiments, the autonomous yard truck 200 may include a fifth-wheel coupling 250. The fifth-wheel coupling 250, for example, may be raised or lowered with a fifth-wheel coupling boom. FIG. 2 shows the fifth-wheel coupling 250 in a lowered position. The fifth-wheel coupling 250 may couple with a kingpin 255 of a trailer 260.

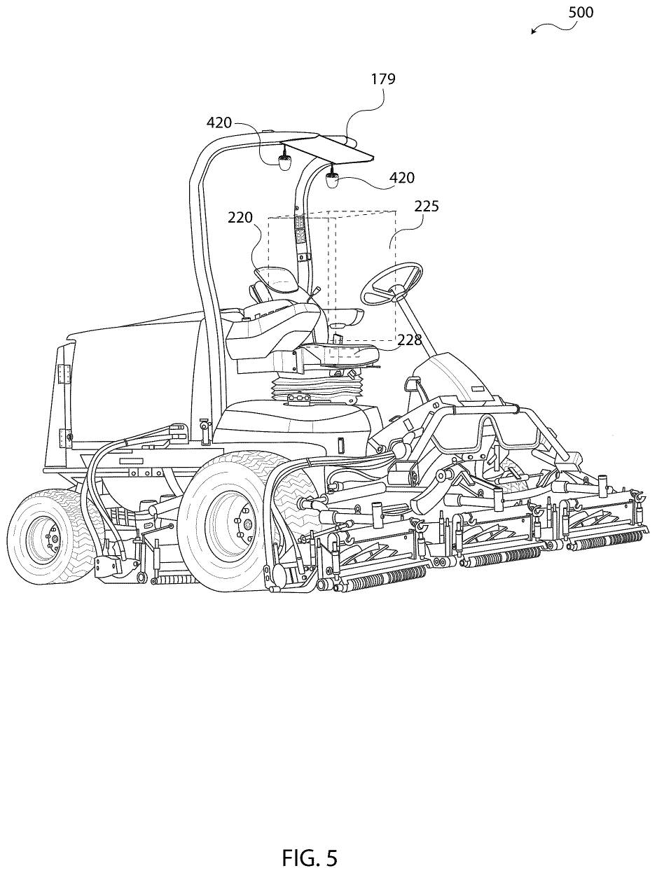

When the fifth-wheel coupling 250 is coupled with a kingpin 255 and the fifth-wheel coupling 250 is in the raised fifth-wheel coupling 250 position, the trailer legs 270 may lift off the ground as shown in FIG. 5. This may allow the autonomous yard truck 200 to pull the trailer 260 without individually raising the trailer legs 270.

In some embodiments, the robotic arm 240 and/or the arm sensor 245 may be coupled with a thermal management system. A thermal management system may, for example, be coupled with a thermal management system associated with the autonomous yard truck 200 such as, for example, coupled with the cab heating/cooling system and/or the engine heating/cooling system. A thermal management system may, for example, be an independent system that heats and/or cools the robotic arm 240 and/or the arm sensor 245. A thermal management system may, for example, keep the temperature of the robotic arm 240 and/or the arm sensor 245 between about 32° F. and about 100° F.

In some embodiments, the autonomous yard truck 200 may include a deployable shade coupled with the back of the cab 201. The deployable shade, for example, may be used to screen the sun and/or other lighting from the arm sensor 245 and/or the one or more backup sensors 135. The deployable shade, for example, may include an umbrella configuration or an awning configuration. The deployable shade, for example, may be coupled with the roof or an upper portion of the cab.

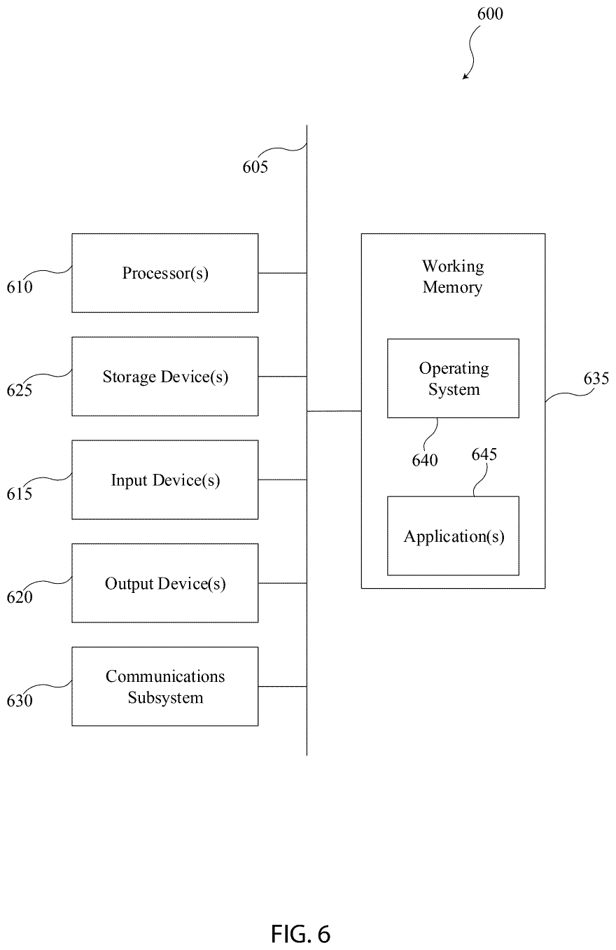

FIG. 2 is a block diagram of a communication and control system 100 that may be utilized in conjunction with the systems and methods of the disclosure. The communication and control system 100 may include a vehicle control unit 150 which may be mounted on an autonomous vehicle 110. The communication and control system 100 may include a sensor array 179, having one or more sensors such as sensors 205 in FIG. 1, which may be mounted on an autonomous vehicle 110. The autonomous vehicle 110, for example, may include a yard truck, loader, wheel loader, track loader, dump truck, digger, backhoe, forklift, etc. The communication and control system 100, for example, may include any or all components of computational unit 600 shown in FIG. 6.

For example, the autonomous vehicle 110 may include a steering control system 144 that may control a direction of movement of the autonomous vehicle 110. The steering control system 144, for example, may include any or all components of computational unit 600 shown in FIG. 6.

The autonomous vehicle 110, for example, may include a speed control system 146 that controls the speed, acceleration, and deceleration of the autonomous vehicle 110. The speed control system 146, for example, may control the speed of the autonomous vehicle 110 based on map data, field-of-view data relating to any data which can represent a volume, such as a model or point cloud of the field of view of the occupancy sensors 205, control algorithms, obstacle detection, start and/or stop points, operator detection in an operator seat, etc. The speed control system 146, for example, may include any or all components of computational unit 600 shown in FIG. 6.

The autonomous vehicle 110, for example, may include an implement control system 148 that may control operation of an implement towed by the autonomous vehicle 110 or integrated within the autonomous vehicle 110 or coupled to the autonomous vehicle 110. The implement control system 148 may, for example, include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 148, for example, may include any or all components of computational unit 600 shown in FIG. 6.

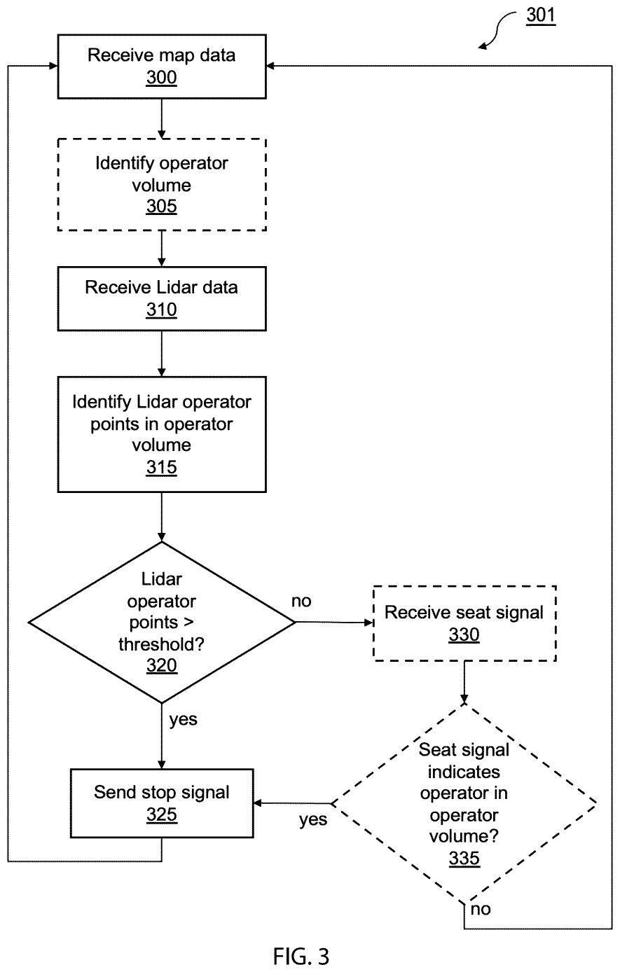

The autonomous vehicle 110, for example, may include an operator detection system 174 that performs an operator check method, such as the example operator check method described with reference to FIG. 3, to determine whether an operator is sat in an operator seat such as the operator seat 220 of FIG. 1, or in other words, whether an operator is present in an operator volume such as the operator volume 225 of FIG. 1. When an operator is determined to be present on the operator seat 220, the operator detection system 174 may transmit a stop signal, for example to the vehicle control unit 150, to stop autonomous operation of the autonomous vehicle 110. The operator detection system 174, for example, may include any or all components of computational unit 600 shown in FIG. 6.

The vehicle control unit 150 may be communicatively coupled with the steering control system 144, the speed control system 146, the implement control system 148, and the operator detection system 174. The vehicle control unit 150, for example, may include any or all the components shown in FIG. 6. The vehicle control unit 150, for example, may be integrated into a single controller or may include a plurality of distinct components or controllers. The vehicle control unit 150 may also be coupled with one or more sensors from the sensor array 179 and receive sensor data from the sensor array 179.

The vehicle control unit 150, for example, may be used to control various aspects of the vehicle such as, for example, sending instructions to the steering control system 144, implement control system 148, speed control system 146, the operator detection system 174 etc. The vehicle control unit 150, for example, may include a vehicle artificial intelligence (VAI) that may include one or more processors that execute one or more algorithms.

The vehicle control unit 150, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensory array 179 or from base station 180.

The vehicle control unit 150, for example, may be an electronic controller with electrical circuitry configured to process data from the various components of the autonomous vehicle 110. The vehicle control unit 150 may include any or all a processor, such as the processor 610, and a working memory 635 shown in FIG. 6. The vehicle control unit 150 may also include one or more storage devices and/or other suitable components of computational system 600. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 150, for example, may include any or all the components shown in FIG. X.

The vehicle control unit 150, for example, may include a volatile memory, such as random-access memory (RAM), and/or a nonvolatile memory, such as ROM (e.g., working memory 635 and/or storage device 625 shown in FIG. 6). The memory may store a variety of information and may be used for various purposes. For example, the memory may store processor-executable instructions (e.g., firmware or software) for the vehicle control unit 150 to execute, such as instructions for calculating drivable path plan, and/or controlling the autonomous vehicle 110. The memory may include flash memory, one or more hard drives, or any other suitable optical, magnetic, or solid-state storage medium, or a combination thereof. The memory may store data such as field-of-view data, the field-of-view data including a representation of the field of view from the occupancy sensors (e.g., occupancy sensors 205a in FIG. 1) and an operator volume (e.g., operator volume 225 in FIG. 1) within the field of view, field maps, or maps of desired paths, and/or data such as vehicle characteristics, software or firmware instructions and/or any other suitable data. The field-of view data may include, for example, a model of the field of view including at least the operator volume, or a point cloud of the field of view of the occupancy system including the operator volume. In some examples, the field-of-view data may simply include coordinate limits in three-dimensional space, the coordinate limits defining boundaries of the operator volume, such that points in a point cloud from the occupancy system may be determined to be in the operator volume when their coordinates fall within the limits for each dimension.

The field-of-view data representing the field of view from the occupancy sensors 205a may be a point cloud or occupancy grid, generated by the occupancy sensors (e.g., Lidar sensors). The point cloud or occupancy grid may be generated when it is known that an operator is not present in the operator seat, so that it is known that the occupancy points generated by the occupancy system are of known, fixed objects, such as the operator seat. With this point cloud, the operator seat may be identified, and the operator volume may be calibrated to the space above the operator seat.

The steering control system 144, for example, may include a curvature rate control system 160, a differential braking system 162, a steering mechanism, and a torque vectoring system 164 that may be used to steer the autonomous vehicle 110. The curvature rate control system 160, for example, may control a direction of an autonomous vehicle 110 by controlling a steering control system of the autonomous vehicle 110 with a curvature rate, such as an Ackerman style autonomous vehicle, 110 or articulating vehicle. The curvature rate control system 160, for example, may automatically rotate one or more wheels or tracks of the autonomous vehicle 110 via hydraulic or electric actuators to steer the autonomous vehicle 110. By way of example, the curvature rate control system 160 may rotate front wheels/tracks, rear wheels/tracks, and/or intermediate wheels/tracks of the autonomous vehicle 110 or articulate the frame of the vehicle, either individually or in groups. The differential braking system 162 may independently vary the braking force on each lateral side of the autonomous vehicle 110 to direct the autonomous vehicle 110. Similarly, the torque vectoring system 164 may differentially apply torque from the engine to the wheels and/or tracks on each lateral side of the autonomous vehicle 110. While the illustrated steering control system 144 includes the curvature rate control system 160, the differential braking system 162, and the torque vectoring system 164, the steering control system 144 may include one or more of these systems. Further examples may include a steering control system 144 having other and/or additional systems to facilitate turning the autonomous vehicle 110 such as an articulated steering control system, a differential drive system, and the like.

The speed control system 146, for example, may include an engine output control system 166, a transmission control system 168, and a braking control system 170. The engine output control system 166 may vary the output of the engine to control the speed of the autonomous vehicle 110. For example, the engine output control system 166 may vary a throttle setting of the engine, a fuel/air mixture of the engine, a timing of the engine, and/or other suitable engine parameters to control engine output. In addition, the transmission control system 168 may adjust gear selection within a transmission to control the speed of the autonomous vehicle 110. Furthermore, the braking control system 170 may adjust braking force to control the speed of the autonomous vehicle 110. While the illustrated speed control system 146 includes the engine output control system 166, the transmission control system 168, and the braking control system 170, the speed control system 146 may include one or two of these systems. The speed control system 146, for example, may also include other systems and/or additional systems that may be used to control the speed of the autonomous vehicle 110.

The implement control system 148, for example, may control various parameters of the implement towed by and/or integrated within the autonomous vehicle 110. For example, the implement control system 148 may instruct an implement controller via a communication link, such as a CAN bus, ISOBUS, Ethernet, wireless communications, and/or Broad R Reach type Automotive Ethernet, etc.

The implement control system 148, for example, may instruct an implement controller to adjust a penetration depth of at least one ground engaging tool of an agricultural implement, which may reduce the draft load on the autonomous vehicle 110.

The implement control system 148, as another example, may instruct the implement controller to transition an agricultural implement between a working position and a transport portion, to adjust a flow rate of product from the agricultural implement, to adjust a position of a header of the agricultural implement (e.g., a harvester, etc.), among other operations, etc.

The implement control system 148, as another example, may instruct the implement controller to adjust a shovel height, a shovel angle, a shovel position, etc.

The communication and control system 100, for example, may include a sensor array 179. The sensor array 179, for example, may facilitate determination of condition(s) of and/or around the autonomous vehicle 110 and/or the work area. For example, the sensor array 179 may include one or more sensors (e.g., infrared sensors, ultrasonic sensors, magnetic sensors, tachometer, radar sensors, Lidar sensors, occupancy sensors, terahertz sensors, sonar sensors, wheel encoders, cameras, stereo cameras etc.) that monitor a rotation rate of a respective wheel or track and/or a ground speed of the autonomous vehicle 110. The sensors may also monitor operating levels (e.g., temperature, fuel level, etc.) of the autonomous vehicle 110. Furthermore, the sensors may monitor conditions in and around the work area, such as temperature, weather, wind speed, compass, humidity, and other conditions. The sensors of the sensor array 179, for example, may detect physical objects in the work area, such as a parking stall, a material stall, accessories, other vehicles, obstacles, environmental features, or other object(s) that may be in the area surrounding the autonomous vehicle 110. The sensors of the sensor array 179, for example, may detect the presence of an operator in an operator seat of the autonomous vehicle 110.

The sensor array 179, for example, may include a velocity sensor which may include one or more of an inertial measurement unit, a compass, a GPS sensor, a wheel encoder, a tachometer, a camera, a radar, Lidar sensors, stereo cameras etc. The sensor array 179, for example, may also include a steering angle sensor. The velocity sensor, for example, may produce velocity data. Velocity data may include speed and/or bearing. Velocity data, for example, may also include steering angular rate.

The operator detection system 174 may be communicatively coupled to the vehicle control unit 150, to the sensor system 179 and/or to a memory, such as the memory on the autonomous vehicle 110, remote from the operator detection system 174, or a memory which is a part of the operator detection system 174.

The operator detection system 174 may, for example, determine whether an operator is present in the operator seat based on data from the sensor array 179. For example, in some embodiments, the operator detection system 174 may determine that an operator is present in the operator seat based on data from occupancy sensors in the sensor array 179, such as the Lidar sensors 205a in FIG. 1. If an operator is determined to be present, the operator detection system 174 may output a stop signal to the vehicle control unit 150 to stop autonomous movement of the autonomous vehicle 110. The stop signal may cause the vehicle control unit 150 to send a signal to the braking control system 170 to brake so that the autonomous vehicle 110 cannot move. If an operator is determined to be present, the operator detection system 174 may send a signal to enable manual control of the autonomous vehicle 110.

In some examples, the operator detection system 174 may detect the presence of an operator in more than one way, by employing more than one detection method to determine the presence of an operator in the operator seat. In some embodiments, the operator detection system 174 may further detect the presence of an operator in the operator volume with a seat sensor, such as the seat sensor 228 in the autonomous yard truck 200 of FIG. 1. Therefore, if the seat sensor 228 indicates that an operator is present in the operator seat 220 in the autonomous yard truck 200 of FIG. 1, the operator detection system 174 may send the stop signal to stop autonomous movement of the autonomous yard truck 200.

In some embodiments, if any of the detection methods detect an operator in the operator seat, even if the different detection methods disagree, the operator detection system 174 may still determine that an operator is present and send the stop signal. In other words, where there is more than one method for detecting the presence of an operator, autonomous movement of the autonomous vehicle 110 may be permitted only when none of sensors in the sensor array 179 detect the presence of an operator. There may be a delay between the determination that an operator is present and sending the stop signal, for example, to confirm the presence of an operator with further data. There may be a delay between sending the stop signal, and allowing the autonomous vehicle to start moving again.

The operator interface 152, for example, may be communicatively coupled to the vehicle control unit 150 and configured to present data from the autonomous vehicle 110 via a display. Display data may include: data associated with operation of the autonomous vehicle 110, data associated with operation of an implement, a position of the autonomous vehicle 110, a speed of the autonomous vehicle 110, a desired path, a drivable path plan, a target position, a current position, determined presence of an operator in the operator seat etc. The operator interface 152 may enable an operator to control certain functions of the autonomous vehicle 110 such as starting and stopping the autonomous vehicle 110, inputting a desired path, manual operation etc. The operator interface 152, for example, may enable the operator to input parameters that cause the vehicle control unit 150 to adjust the drivable path plan. For example, the operator may provide an input requesting that the desired path be acquired as quickly as possible, that an off-path normal error be minimized, that a speed of the autonomous vehicle 110 remains within certain limits, that a lateral acceleration experienced by the autonomous vehicle 110 remains within certain limits, etc. In addition, the operator interface 152 (e.g., via the display, or via an audio system (not shown), etc.) may alert an operator if the desired path cannot be achieved, for example.

The vehicle control unit 150, for example, may include a base station 180 having a base station controller 184 located remotely from the autonomous vehicle 110. For example, the control functions of the vehicle control unit 150 may be distributed between the vehicle control unit 150 of the autonomous vehicle control unit 150 and the base station controller 184. The base station controller 184, for example, may perform a substantial portion of the control functions of the vehicle control unit 150. For example, a first transceiver 178 positioned on the autonomous vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 186 at the base station 180. The base station controller 184, for example, may calculate drivable path plans and/or output control signals to control the curvature rate control system 160, the speed control system 146, and/or the implement control system 148 to direct the autonomous vehicle 110 toward the desired path, for example. The base station controller 184 may include a processor and memory device having similar features and/or capabilities as the processor and the memory device discussed previously. Likewise, the base station 180 may include an operator interface 186 having a display 188, which may have similar features and/or capabilities as the operator interface 152 and the display discussed previously.

In some embodiments, one or both of the base station 180 and/or the autonomous vehicle 110 may be in communication with a user device 190. A user device may include a phone, tablet, laptop, or computer. The user device 190, for example, can include an application that allows the user to communicate commands to the autonomous vehicle 110 and/or receive information about the autonomous vehicle 110. Alternatively, or additionally, the user device 190, for example, can include an application that allows the user to observe the autonomous vehicle 110 move through a map of the work area where the autonomous vehicle operates.

The user device 190, for example, may include an application that can display any suitable GUIs. The user device 190, for example, may include an application that can receive any of the user inputs disclosed in this document. The user device 190, for example, may include an application that can display any of the information disclosed in this document.

FIG. 3 is a flow diagram showing an example operator check method 301 which begins at block 300 and may be carried out by the operator detection system 174. The method 301 will be described with reference to the systems in FIGS. 1 and 2, but it will be appreciated that the method can be carried out on any suitable system.

In block 300, the operator detection system 174 may receive field-of-view data representing the view from the occupancy system. The field-of-view data may include a representation of the operator volume 225. The field-of-view data may be received from the memory on the autonomous vehicle 110, the memory on the base station 180 or a memory which is a part of the operator detection system 174. The method may then proceed to block 305. The field-of-view data may be based on the field of view of the occupancy system and may include a point cloud from the occupancy system or an occupancy grid, such that if the field of view of the occupancy system is changed, for example, if the occupancy sensors 205a are moved, the field-of-view data may be updated. The field-of-view data may be occupancy points, such as Lidar points, which are identified as being part of fixed objects in the field of view of the occupancy system. For example, the operator seat 220 may be identified as being a fixed object in the occupancy sensors'205a field of view. The user device 190 may enable an operator to recalibrate the system when the operator seat 220 is empty so that the fixed objects can be identified with occupancy points from the occupancy system to generate the field-of-view data representing the occupancy system field of view.

In block 305, the operator detection system 174 may identify the operator volume within the field-of-view data and the occupancy points. The field-of-view data may show a representation of the field of view of the occupancy system, which may include fixed objects such as the cab 201 frame and the operator seat 220. For a newly set up occupancy system, or a occupancy system which has moved, the occupancy sensors 205a may need to be calibrated so that the operator volume can be identified. The operator volume may be identified as any suitable volume in three-dimensional space, such as a volumetric box, a mesh or a solid model in three-dimensional space which is calibrated in the field of view of the occupancy system to where an operator would be located when they are sitting on the operator seat 220 (e.g., a volumetric box which is located above the operator seat 220). Identifying the operator volume 225 in this manner means that the system can be retrofitted onto any autonomous vehicle 110 or modified when on the autonomous vehicle 110. The method may then proceed to block 310. In some examples, block 305 may be omitted, as the operator detection system 174 may already be calibrated correctly. Including block 305 means that the system can be continually calibrated, for example every time the autonomous vehicle 110 is started up and/or whenever it is in use, in case the occupancy sensors 205a are moved or knocked out of place.

In block 310, the operator detection system 174 may receive occupancy data, such as Lidar data, from the occupancy system including the occupancy sensors 205a. The method 301 may then proceed to block 315.

In block 315, the operator detection system 174 may identify occupancy points which are within the operator volume 225. The occupancy points which are identified as being within the operator volume 225 may be considered to be operator points. The method 301 may then proceed to block 320.

In block 320, the operator detection system 174 may total the operator points (i.e., the occupancy points within the operator volume 225) and may compare the total number of operator points to an occupancy threshold. If the total number of operator points exceeds the occupancy threshold, the operator detection system 174 determines that an operator is located in the operator seat 220, and the method 301 proceeds to block 325. In some embodiments, the total number of operator points must exceed the threshold for a predetermined period of time, such as 0.5 seconds, 1 second, or 2 seconds, for the method 301 to proceed to block 325. If the total number of operator points does not exceed the occupancy threshold, then the operator detection system 174 determines that an operator is not located in the operator seat 220. In some embodiments, when the operator detection system 174 determines that an operator is not located in the operator seat 220, the method 301 may proceed to block 330. In other embodiments, when the operator detection system 174 determines that an operator is not located in the operator seat 220, the method 301 may do nothing and return to block 300. Therefore, in some examples, blocks 330 and 335 may be omitted from the method 301.

There may be a delay between block 320 and 325, for example, to give the operator an opportunity to move from the seat of their own volition, or to repeat block 310, 315 and 320 before confirming that an operator is present. In block 325, the operator detection system 174 sends a stop signal to the vehicle control unit 150 to stop autonomous movement of the autonomous vehicle 110. In some embodiments, the stop signal cannot be overridden by an operator, and can only be removed when the method 301 no longer determines that an operator is in the operator seat 220. There may be a delay between a determination that the operator is no longer in the operator seat and the removal of the stop signal or allowance of starting movement of the autonomous vehicle 110. For example, the operator may still be in danger from the autonomous vehicle 110 while they are moving away from the autonomous vehicle. In other embodiments, the stop signal may be overridden by an operator if, for example, there is no operator in the operator seat 220, and the method 301 has falsely determined that there is an operator in the operator seat 220. The stop signal may be overridden on the operator interface 192 on the user device 190. The user device 190 may require that it is a predetermined distance away from the autonomous vehicle 110 before it can allow a stop signal to be overridden by the operator on the operator interface 192. It may be that the stop signal cannot be overridden from the operator interface 152 on the autonomous vehicle 110 as this would mean that the operator is in the autonomous vehicle 110 and possibly in the operator volume 225.

In block 330, the operator detection system 174 receives a seat signal from the seat sensor 228. The method 301 then proceeds to block 335.

In block 335, the operator detection system 174 determines whether the seat signal indicates that an operator is in the operator seat 220. For example, where the seat sensor 228 is a pressure sensor, the seat signal may indicate that an operator is present in the operator seat 220 when the seat signal shows a pressure above a pressure threshold. If the seat signal indicates that an operator is present in the operator seat 220, the method 301 may proceed to block 325. If the seat signal indicates that no operator is present in the operator seat 220, the method 301 may return to block 300. In this manner, when either the occupancy sensors 205a or the seat sensor 228 indicates that an operator is present in the operator seat 220, the method 301 may proceed to block 325 to send a stop signal, whether or not the indication from the occupancy sensors 205a and seat sensor 228 is the same. Therefore, the autonomous vehicle 110 is only allowed to operate autonomously when both the occupancy sensors 205a and the seat sensor 228 indicate that no operator is present in the operator volume 225.

In some embodiments, the operator check method 301 may be carried out regularly, at predetermined time intervals, when the vehicle control unit 150 is autonomously controlling movement of the autonomous vehicle 110. In other embodiments, it may be carried out only on initiation of an autonomous mode on the autonomous vehicle 110, or only at start-up of the autonomous vehicle 110.

The order of the various blocks in process 301 can occur in any order. Additionally, or alternatively, one or more blocks may be skipped, one or more blocks may be performed in parallel, and/or one or more blocks may be combined, and/or one or more blocks may be performed in any number of sub-blocks.

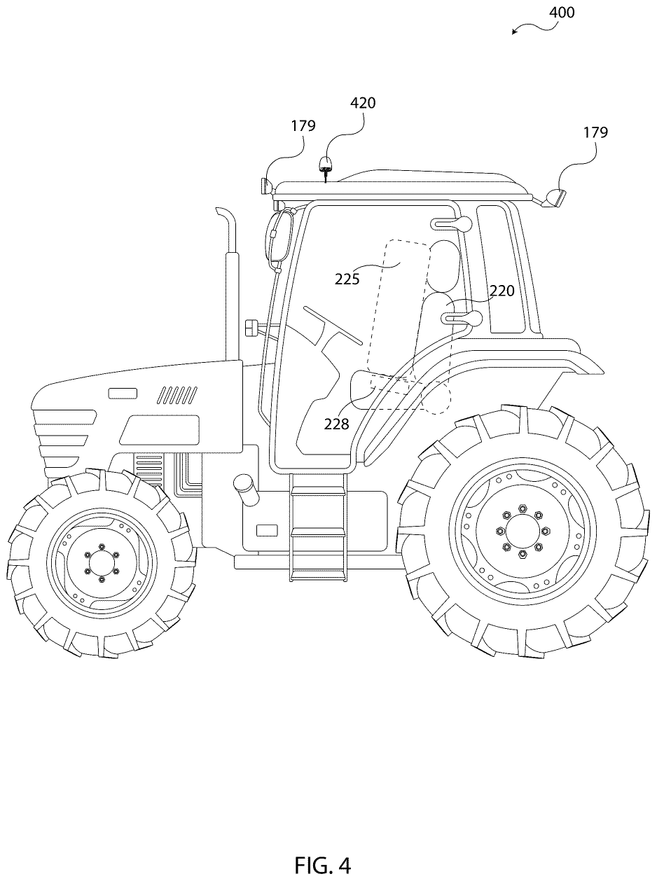

FIG. 4 is a sideview of an example autonomous tractor 400, which may include all or some of the components of autonomous vehicle 110. The autonomous vehicle 110 in this document may include the autonomous tractor 400. In this example, the autonomous tractor 400 may include standard tractor equipment and/or components. The autonomous tractor 400 may include or be coupled with any kind of implement such as, for example, plow, disc plow, reel mower, dumper, lift, bucket, shovel, blade, cutter, etc. The autonomous tractor 400 includes, for example, an operator seat 220, similar to the operator seat 220 on the autonomous yard truck 200 of FIG. 1. The autonomous tractor 400, for example, includes a sensor array (or multiple sensor arrays) including a occupancy system with occupancy sensors 205a and an operator volume 225, in a similar manner to the occupancy system and operator volume 225 on the autonomous yard truck 200 of FIG. 1. The sensor array may include, for example, one or more lidar, radar, stereo cameras and/or video cameras. The video cameras, for example, may include 360-degree cameras, a front facing camera, and/or a back facing camera. The sensor array may include a seat sensor 228 in a similar manner to the seat sensor 228 on the autonomous yard truck 200 of FIG. 1.

FIG. 5 is a sideview of an example autonomous mower 500, which may include all or some of the components of autonomous vehicle 110. The autonomous vehicle 110 in this document may include the autonomous mower 500. In this example, the autonomous mower 500 includes a disc mower 545. Any type of mower or blades may be used instead of the disc mower. The autonomous mower 500 includes, for example, an operator seat 220, similar to the operator seat 220 on the autonomous yard truck 200 of FIG. 1. The autonomous mower 500, for example, includes a sensor array (or multiple sensor arrays) including an occupancy system with occupancy sensors 205a and an operator volume 225, in a similar manner to the occupancy system and operator volume 225 on the autonomous yard truck 200 of FIG. 1. The sensor array may include a seat sensor 228 in a similar manner to the seat sensor 228 on the autonomous yard truck 200 of FIG. 1. The sensor array may include, for example, one or more lidar, radar, stereo cameras and/or video cameras. The video cameras, for example, may include 360-degree cameras, a front facing camera, and/or a back facing camera.

The computational system 600, shown in FIG. 6 can be used to perform any of the examples disclosed in this document. For example, computational system 600 can be used to execute process 300. As another example, computational system 600 can perform any calculation, identification and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard and/or the like; and one or more output devices 620, which can include without limitation a display device, a printer and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described in this document. The computational system 600, for example, may include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 625 described above.

The storage medium, for example, might be incorporated within the computational system 600 or in communication with the computational system 600. The storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

Although term “autonomous vehicle” includes manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The conjunction “or” is inclusive.

The terms “first”, “second”, “third”, etc. are used to distinguish respective elements and are not used to denote a particular order of those elements unless otherwise specified or order is explicitly described or required.

Numerous specific details are set forth to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more examples disclosed in this document. Any suitable programming, scripting, or other type of language or combinations of languages may be used to implement the teachings contained in software to be used in programming or configuring a computing device.

Embodiments of the methods disclosed may be performed in the operation of such computing devices. The order of the blocks presented in the examples above can be varied; for example, blocks can be re-ordered, combined, and/or broken into sub-blocks. Certain blocks or processes can be performed in parallel.

The use of “adapted to” or “configured to” is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included are for ease of explanation only and are not meant to be limiting.

While the present subject matter has been described in detail with respect to specific examples, those skilled in the art, upon attaining an understanding of these examples, may readily produce alterations to, variations of, and equivalents to such examples. Accordingly, the present disclosure has been presented for purposes of example rather than limitation, and does not preclude inclusion of such modifications, variations and/or additions to the present subject matter as would be readily apparent to one of ordinary skill in the art. That which is claimed:

1. An autonomous vehicle comprising:
an operator seat;
an occupancy system comprising one or more remote occupancy sensors to capture occupancy data comprising a plurality of occupancy points, wherein a three-dimensional operator volume is in a field of view of the occupancy system, the operator volume being defined as a volume above the operator seat in which an operator may be located when sitting in the operator seat;
a vehicle control unit for autonomously controlling movement of the autonomous vehicle;
a digital storage medium comprising field-of-view data representing the field of view of the occupancy system, the field-of-view data including a representation of the operator volume; and
an operator detection system in communication with the digital storage medium, occupancy system, and the vehicle control unit, wherein the operator detection system performs an operator check by:
receiving the field-of-view data from the digital storage medium;
receiving the occupancy data from the occupancy system;
identifying occupancy points within the operator volume of the field-of-view data; and
if the total number of occupancy points in the operator volume exceeds an occupancy threshold for a predetermined period of time, determining that an operator is located in the operator seat; and
in response to determining that an operator is located in the operator seat, sending a stop signal to the vehicle control unit to stop autonomous movement of the autonomous vehicle.

2. The autonomous vehicle according to claim 1, comprising a seat sensor in the operator seat which detects the presence of an operator in the operator seat.

3. The autonomous vehicle according to claim 2, wherein the stop signal is sent to the vehicle control unit further when the seat sensor detects the presence of an operator on the operator seat.

4. The autonomous vehicle according to claim 3, wherein autonomous movement of the autonomous vehicle is only permitted when the seat sensor does not detect the presence of an operator on the operator seat and when the total number of occupancy points in the operator volume does not exceed the occupancy threshold for a predetermined period of time.

5. The autonomous vehicle according to claim 2, wherein the seat sensor is a pressure sensor to detect the weight of an operator on the operator seat, and wherein the operator detection system determines that an operator is located in the operator seat when the pressure sensors detects a pressure higher than a pressure threshold.

6. The autonomous vehicle according to claim 1, wherein the field-of-view data is generated by the occupancy system and includes a point cloud or an occupancy grid representing fixed objects, including the operator volume, in the field of view of the occupancy system.

7. The autonomous vehicle according to claim 1, wherein when the stop signal is sent to the vehicle control unit, manual control of the autonomous vehicle is enabled.

8. The autonomous vehicle according to claim 1, wherein the operator detection system performs the operator check regularly, at predetermined time intervals, when the vehicle control unit autonomously controls movement of the autonomous vehicle.

9. The autonomous vehicle according to claim 1, wherein the occupancy sensor is a Lidar sensor to capture Lidar data comprising a plurality of Lidar points.

10. A method comprising:
receiving field-of-view data representing a field of view of an occupancy system on an autonomous vehicle, including a view of an operator seat on the autonomous vehicle and a three-dimensional operator volume defined as a volume above the operator seat in which an operator may be located when sitting in the operator seat;
receiving occupancy data, comprising a plurality of occupancy points, captured by the occupancy system on the autonomous vehicle;
identifying occupancy points within the operator volume; and
if the total number of occupancy points in the operator volume exceeds an occupancy threshold for a predetermined period of time, determining that an operator is located in the operator seat; and
in response to determining that an operator is located in the operator seat, sending a stop signal to a vehicle control unit on the autonomous vehicle to stop autonomous movement of the autonomous vehicle.

11. The method according to claim 10, further comprising receiving a seat signal from a seat sensor on the autonomous vehicle, determining the presence of an operator in the operator volume when the seat signal indicates the presence of a person in the operator seat, and further sending a stop signal to the vehicle control unit when the seat signal indicates the presence of a person in the operator seat.

12. The method according to claim 11, wherein autonomous movement of the autonomous vehicle is only permitted when both the seat signal indicates the that there is no person present in the operator seat and when the total number of occupancy points in the operator volume does not exceed the occupancy threshold for a predetermined time period.

13. The method according to claim 11, wherein the seat signal is a pressure signal from a pressure sensor to detect the weight of an operator on the operator seat, and wherein the method comprises determining that an operator is located in the operator seat when the pressure sensors detects a pressure higher than a pressure threshold.

14. The method according to claim 10, wherein the field-of-view data is generated by the occupancy system and includes a point cloud or an occupancy grid representing fixed objects in the field of view of the occupancy system.

15. The method according to claim 10, comprising enabling manual control of the autonomous vehicle when the stop signal is sent to the vehicle control unit.

16. The method according to claim 10, wherein the method is performed when the autonomous vehicle is being autonomously controlled.

17. The method according to claim 10, wherein the occupancy sensor is a Lidar sensor to capture Lidar data comprising a plurality of Lidar points.

18. An autonomous vehicle comprising:
an operator seat;
a pressure sensor in the operator seat which detects the presence of an operator on the operator seat by detecting the weight of an operator on the operator seat;
a Lidar system comprising one or more Lidar sensors to capture Lidar data including a plurality of Lidar points, wherein a three-dimensional operator volume is in a field of view of the Lidar system, the operator volume being defined as a volume above the operator seat in which an operator may be located when sitting in the operator seat;
a vehicle control unit for autonomously controlling movement of the autonomous vehicle;
a digital storage medium comprising field-of-view data representing the field of view of the Lidar system, the field-of-view data including a representation of the operator volume; and
an operator detection system in communication with the digital storage medium, Lidar system, and the vehicle control unit, wherein the operator detection system regularly performs an operator check, at predetermined time intervals, when the vehicle control unit autonomously controls movement of the autonomous vehicle, the operator check comprising:
receiving field-of-view data from the digital storage medium;
receiving the Lidar data from the Lidar system;
identifying Lidar points within the operator volume; and
calculating the total number of Lidar points in the operator volume and if (i) the total number of Lidar points in the operator volume exceeds a Lidar threshold for a predetermined period of time, and/or (ii) the pressure sensor detects the presence of an operator on the operator seat:
determining that an operator is located in the operator seat and sending a stop signal to the vehicle control unit to stop autonomous movement of the autonomous vehicle;
wherein autonomous movement of the autonomous vehicle is only permitted when it can be determined from signals from both the Lidar system and the pressure sensor that there is no operator present on the operator seat.
